(19) United States
(12) Patent Application Publication
(10) Pub. No.: US 2021/0269675 A1
(43) Pub. Date: Sep. 2, 2021

(54) SLURRY COMPOSITION FOR CHEMICAL MECHANICAL POLISHING

(71) Applicant: KCTECH CO., LTD., Gyeonggi-do (KR)

(72) Inventors: Jin Sook HWANG, Gyeonggi-do (KR); Hyun Goo KONG, Gyeonggi-do (KR); In Seol HWANG, Gyeonggi-do (KR)

(73) Assignee: KCTECH CO., LTD., Gyeonggi-do (KR)

(21) Appl. No.: 17/184,620

(22) Filed: Feb. 25, 2021

(30) Foreign Application Priority Data
Feb. 27, 2020 (KR) 10-2020-0024087

(51) Int. Cl. C09G 1/02; C09K 13/00; C09K 13/04

(52) U.S. Cl. CPC C09G 1/02; C09K 13/04; C09K 13/00

(57) ABSTRACT

A slurry composition for chemical mechanical polishing (CMP) is provided. The slurry composition for CMP includes abrasive particles, an oxidizer, and a carbon polishing inhibitor.

### CROSS-REFERENCE TO RELATED APPLICATION(S)

This application claims the benefit of Korean Patent Application No. 10-2020-0024087, filed on Feb. 27, 2020, in the Korean Intellectual Property Office, the disclosure of which is incorporated herein by reference.

### BACKGROUND

### 1. Field of the Invention

Example embodiments relate to a slurry composition for chemical mechanical polishing (CMP).

### 2. Description of the Related Art

As semiconductor elements become diverse and highly integrated, finer pattern forming techniques are being used, and accordingly the surface structure of the semiconductor elements is becoming more complicated and a step height of surface films also becomes greater. A chemical mechanical polishing (CMP) process is used as a planarization technique for removing a step height on a specific film formed on a substrate in manufacture of the semiconductor elements. The CMP process includes seating a wafer to perform a planarization process on a rotary plate, bringing the surface of the wafer into contact with a pad of a polishing machine, and then supplying a slurry composition and rotating the rotary plate and the pad of the polishing machine, thereby performing the polishing process. That is, as the slurry composition flows between the wafer surface and the pad, polishing of the wafer surface is accomplished by the mechanical friction due to abrasive particles within the slurry composition and surface protrusions of the pad, and chemical removal is accomplished by a chemical reaction between chemical components inside the slurry composition and the wafer surface at the same time. The polishing efficiency of the CMP process is determined by CMP equipment, composition of the slurry composition, types of a polishing pad, etc. Particularly, the composition of the slurry composition has an important effect on the polishing efficiency. With regard to a slurry composition with the same composition, the polishing speed of the film may vary depending on properties of a film, and the polishing precision of the film may be adjusted by using a difference between such polishing speeds. For example, the CMP process may be classified into an oxide film CMP process, a metal CMP process, a polysilicon (poly-Si) CMP process, an organic film CMP process, and the like depending on polishing target materials.

The CMP process is often carried out due to a polishing speed difference between an oxide film, a nitride film, a metal film, and a polysilicon film widely used in semiconductor devices. Particularly, a slurry composition that polishes the oxide film, nitride film, and polysilicon film at the same time among these slurry compositions has been used. However, as the slurry composition that polishes the oxide film, nitride film, and polysilicon film at the same time lacks a polishing stop function, there is a problem that dishing and erosion occur when separating elements. Therefore, a slurry composition for CMP capable of selectively polishing necessary films is required according as a semiconductor device is being highly integrated.

### SUMMARY

The present disclosure is to solve the foregoing problems, and an aspect of the present disclosure is to provide a slurry composition for chemical mechanical polishing (CMP), the slurry composition which is capable of selectively inhibiting the polishing rate of a carbon film while maintaining polishing rates of a nitride film, an insulation film, a metal film, and a polysilicon film at a certain level.

However, the problems to be solved in the present disclosure are not limited to the foregoing problems, and other problems not mentioned herein would be clearly understood by one of ordinary skill in the art from the following description.

According to an aspect, there is provided a slurry composition for CMP including abrasive particles, an oxidizer, and a carbon polishing inhibitor.

The abrasive particles may include at least one of a metal oxide, an organic or inorganic matter-coated metal oxide, and the metal oxide in a colloidal state, and the metal oxide may include at least one of silica, ceria, zirconia, alumina, titania, barium titania, germania, mangania, and magnesia.

The abrasive particles may include primary particles having a particle size of 10 nm to 200 nm and secondary particles having a particle size of 30 nm to 300 nm.

The abrasive particles may be present in an amount of 0.1 wt % to 10 wt % in the slurry composition.

The oxidizer may include at least one of hydrogen peroxide, urea hydrogen peroxide, urea, percarbonate, periodic acid, periodate, perchloric acid, perchlorate, perbromic acid, perbromate, perboric acid, perborate, permanganic acid, permanganate, persulfate, bromate, chlorate, chlorite, chromate, iodate, iodic acid, ammonium persulfate, benzoyl peroxide, calcium peroxide, barium peroxide, sodium peroxide, and carbamide peroxide.

The oxidizer may be present in an amount of 0.05 wt % to 5 wt % in the slurry composition.

The carbon polishing inhibitor may include an anionic functional group with 6 to 20 carbon atoms, anionic and cationic functional groups with 6 to 20 carbon atoms, or both thereof.

The carbon polishing inhibitor may include an anionic surfactant, an amphoteric surfactant, or both thereof.

The anionic surfactant may include at least one of ammonium lauryl sulfate, sodium dodecyl sulfate, sodium polyoxyethylene alkyl aryl sulfate, ammonium polyoxyethylene alkyl aryl sulfate, alkyl ether phosphate, sodium lauryl sulfate, sodium laureth sulfate, ammonium laureth sulfate, sodium cocoyl methyl taurate, disodium laureth sulfosuccinate, disodium lauryl sulfosuccinate, disodium cocoyl glutamate, sodium cocoyl glutamate, sodium cocoyl glycinate, sodium lauroyl sarcosinate, sodium cocoyl alaninate, sodium cocoyl isethionate, sodium lauroyl methyl isethionate, sodium laureth carboxylate, and sodium C₁₄₋₁₆ olefin sulfonate.

The amphoteric surfactant may include at least one of cocamidopropyl betaine, lauramidopropyl betaine, alkyl betaine, amido betaine, sulfobetaine, hydroxysulfobetaine, amidosulfobetaine, phosphobetaine, imidazolinium betaine, alkyl amido betaine, alkyl amide propyl betaine, alkyl dimethyl amine betaine, alkyl dimethyl betaine, apricotamidopropyl betaine, coco amido betaine, coco betaine, cocoamidpropyl betaine, coco dimethyl betaine, lauryl betaine, lauryl amido propyl betaine, wheat germanidopropyl betaine, isostearamidopropyl betaine, myristamidopropyl betaine, palmitamidopropyl betaine, undecylenamidopropyl betaine, 2-alkyl-N-carboxymethyl-N-hydroxyethyl imidazolinium betaine, lauramidopropyl hydroxysultaine, lauryl hydroxysultaine, cocomidopropyl hydroxysultaine, sodium lauroamphoacetate, and sodium cocoamphoacetate.

The carbon polishing inhibitor may be present in an amount of 0.0001 wt % to 1 wt % in the slurry composition.

The slurry composition may further include at least one of a metal polishing improver, a metal polishing inhibitor, a nitride film polishing improver, a nitride film polishing inhibitor, a poly film polishing improver, and a poly film polishing inhibitor.

The slurry composition may have a contact angle range of 10° to 70°.

The slurry composition may have a pH range of 2.0 to 6.0.

A polishing target film may include at least one of a nitride film, an insulation film, a metal film, a polysilicon film, and a carbon film.

The carbon film may have a polishing amount of less than 20 Å/min,

Additional aspects of example embodiments will be set forth in part in the description which follows and, in part, will be apparent from the description, or may be learned by practice of the disclosure.

According to example embodiments, a slurry composition for CMP may inhibit polishing of a carbon film selectively and effectively while maintaining the polishing rate of a nitride film, an insulation film, a metal film, and a polysilicon film at a certain level. The present disclosure provides a slurry composition for CMP which effectively inhibits polishing of the carbon film by adjusting the surface energy between the carbon film and the slurry composition, thereby maximizing the interaction between the carbon film and the slurry composition.

### DETAILED DESCRIPTION

Hereinafter, example embodiments of the present disclosure will be described in detail. When it is determined detailed description related to a related known function or configuration they may make the purpose of the present disclosure unnecessarily ambiguous in describing the present disclosure, the detailed description will be omitted here. Also, terminologies used herein are defined to appropriately describe the example embodiments and thus may be changed depending on a user, the intent of an operator, or a custom of a field to which the present disclosure pertains. Accordingly, the terminologies must be defined based on the following overall description of the present specification.

In the whole specification, when any member is positioned “on” the other member, this not only includes a case that the any member is brought into contact with the other member, but also includes a case that another member exists between two members.

In the whole specification, if a prescribed part “includes” a prescribed element, this means that another element may be further included instead of excluding another element.

Hereinafter, a slurry composition for chemical mechanical polishing (CMP) according to the present disclosure will be described in detail with reference to examples. However, the present disclosure is not limited to such examples.

A slurry composition for CMP according to example embodiments of the present disclosure may include abrasive particles, an oxidizer, and a carbon polishing inhibitor.

A slurry composition for CMP according to example embodiments of the present disclosure may inhibit polishing of a carbon film selectively and effectively while maintaining the polishing rate of a nitride film, an insulation film, a metal film, and a polysilicon film at a certain level. Furthermore, the present disclosure provides a slurry composition for CMP which effectively inhibits polishing of the carbon film by adjusting the surface energy between the carbon film and the slurry composition, thereby maximizing the interaction between the carbon film and the slurry composition.

In an example embodiment, the abrasive particles may include at least one of a metal oxide, an organic or inorganic matter-coated metal oxide, and the metal oxide in a colloidal state, and the metal oxide may include at least one of silica, ceria, zirconia, alumina, titania, barium titania, germania, mangania, and magnesia.

According to an example embodiment, the abrasive particles may be manufactured by a liquid phase method, and the abrasive particles may be dispersed so that the surface of the abrasive particles has a negative charge. Although the abrasive particles may include abrasive particles manufactured by the liquid phase method, the present disclosure is not limited thereto. The abrasive particles may be manufactured by applying a sol-gel method of generating a chemical reaction of an abrasive particle precursor in an aqueous solution and growing a crystal to obtain fine particles, a coprecipitation method of precipitating abrasive particle ions in the aqueous solution, a hydrothermal synthesis method of forming abrasive particles under high temperatures and high pressures, or the like to the liquid phase method. The abrasive particles manufactured by the liquid phase method are dispersed so that the surface of the abrasive particles has a negative charge.

In an example embodiment, the abrasive particles may include primary particles having a particle size of 10 nm to 200 nm and secondary particles having a particle size of 30 nm to 300 nm. An average particle diameter of the abrasive particles is an average particle diameter value of a plurality of particles within a view field range that may be measured by scanning electron microscope analysis or dynamic light scattering. In the particle size of the primary particles, the particle size of the primary particles should be 200 nm or less to secure particle uniformity, and polishing rate may be lowered when the particle size of the primary particles is less than 5 nm. In the particle size of the secondary particles in the slurry composition for CMP, cleaning ability is lowered, and defects are excessively generated on a wafer surface if small particles are excessively generated due to a milling operation when the particle size of the secondary particles is less than 30 nm. As an overpolishing operation is conducted when the particle size of the secondary particles is more than 300 nm, it becomes difficult to control selectivity, and there is a possibility that dishing, erosion and surface defects are generated.

According to an example embodiment, the abrasive particles may include mixed particles having a multi-dispersion type particle distribution in addition to single-sized particles. For example, the mixed particles may have a bimodal type particle distribution by mixing two types of abrasive particles having different average particle sizes, a particle size distribution showing three peaks by mixing three types of abrasive particles having different average particle sizes, or a multi-dispersion type particle distribution by mixing four or more types of abrasive particles having different average particle sizes. The mixed particles may expect effects of having more excellent dispersibility and reducing scratches on the wafer surface by mixing relatively large abrasive particles with relatively small abrasive particles.

According to an example embodiment, the shape of the abrasive particles may include at least one of a spherical shape, a square shape, an acicular shape, and a plate shape, and the shape of the abrasive particles may preferably be the spherical shape.

According to an example embodiment, the abrasive particles may be monocrystalline. When monocrystalline abrasive particles are used, the monocrystalline abrasive particles may achieve a scratch reduction effect, may improve dishing, and may improve cleaning ability after polishing compared to polycrystalline abrasive particles.

In an example embodiment, the abrasive particles may be present in an amount of 0.1 wt % to 10 wt % in the slurry composition for CMP. There is a problem of decreasing the polishing speed when the abrasive particles are present in an amount of less than 0.1 wt % in the slurry composition for CMP, and the polishing speed is too high, and surface defects may be generated by adsorbability of the particles remained on the surface due to an increase in the number of abrasive particles when the abrasive particles are present in an amount of more than 10 wt % in the slurry composition for CMP.

In an example embodiment, the oxidizer may include at least one of hydrogen peroxide, urea hydrogen peroxide, urea, percarbonate, periodic acid, periodate, perchloric acid, perchlorate, perbromic acid, perbromate, perboric acid, perborate, permanganic acid, permanganate, persulfate, bromate, chlorate, chlorite, chromate, iodate, iodic acid, ammonium persulfate, benzoyl peroxide, calcium peroxide, barium peroxide, sodium peroxide, and carbamide peroxide.

In an example embodiment, the oxidizer may be present in an amount of 0.05 wt % to 5 wt % in the slurry composition for CMP. The polishing speed and oxidation rate for a polishing target film may be deteriorated when the oxidizer is present in an amount of less than 0.05 wt % in the slurry composition for CMP, and a secondary problem such as dishing or erosion in the pattern may be caused as the polishing target film is excessively polished when the oxidizer is present in an amount of more than 5 wt % in the slurry composition for CMP.

In an example embodiment, the carbon polishing inhibitor may include an anionic functional group with 6 to 20 carbon atoms, anionic and cationic functional groups with 6 to 20 carbon atoms, or both thereof.

In an example embodiment, the carbon polishing inhibitor may include an anionic surfactant, an amphoteric surfactant, or both thereof.

In an example embodiment, the anionic surfactant may include at least one of ammonium lauryl sulfate, sodium dodecyl sulfate, sodium polyoxyethylene alkyl aryl sulfate, ammonium polyoxyethylene alkyl aryl sulfate, alkyl ether phosphate, sodium lauryl sulfate, sodium laureth sulfate, ammonium laureth sulfate, sodium cocoyl methyl taurate, disodium laureth sulfosuccinate, disodium lauryl sulfosuccinate, disodium cocoyl glutamate, sodium cocoyl glutamate, sodium cocoyl glycinate, sodium lauroyl sarcosinate, sodium cocoyl alaninate, sodium cocoyl isethionate, sodium lauroyl methyl isethionate, sodium laureth carboxylate, and sodium C₁₄₋₁₆ olefin sulfonate.

In an example embodiment the amphoteric surfactant may include at least one of cocamidopropyl betaine, lauramidopropyl betaine, alkyl betaine, amido betaine, sulfobetaine, hydroxysulfobetaine, am idosulfobetaine, phosphobetaine, imidazolinium betaine, alkyl amido betaine, alkyl amide propyl botanic, alkyl dimethyl amine betaine, alkyl dimethyl betaine, apricotamidopropyl betaine, coco amido betaine, coco betaine, cocoamidopropyl betaine, Coco dimethyl betaine, lauryl betaine, lauryl arriido propyl betaine, wheat germanidopropyl betaine, isostearamidopropyl betaine, myristamidopropyl betaine, palmitamidopropyl betaine, undecylenamidopropyl betaine, 2-alkyl-N-carboxymethyl-N-hydroxyethyl imidazolinium betaine, lauramidopropyl hydroxysultaine, lauryl hydroxysultaine, cocamidopropyl hydroxysultaine, sodium lauroamphoacetate, and sodium cocoamphoacetate.

In an example embodiment, the carbon polishing, inhibitor may be in an amount of 0.0001 wt % to 1 wt % m the slurry composition for CMP. A function of inhibiting polishing of a carbon film may not be exerted when the carbon polishing inhibitor is present in an amount of less than 0.0001 wt % in the slurry composition for CMP, and stability of the slurry composition for CMP may be decreased when the carbon polishing inhibitor is present in an amount of more than 1 wt % in the slurry composition for CMP.

In an example embodiment, the slurry composition may further include at least one of a metal polishing improver, a metal polishing inhibitor, a nitride film polishing improver, a nitride film polishing inhibitor, a poly film polishing improver, and a poly film polishing inhibitor.

In an example embodiment, the slurry composition for CMP may have a contact angle range of 10° to 70°.

The angle at which a liquid droplet on a solid surface forms from the surface is called a contact angle (surface tension). The contact angle is formed when a surface energy between solids is in thermodynamic equilibrium, and the same type of liquid has the same contact angle anywhere on the solid surface when physical and chemical properties of the solid surface are uniform. The smaller the contact angle is, the more the surface is wetted by liquid, and the larger the contact angle is, the more likely the liquid tends to flow off the surface without getting wet well.

Stability of the slurry composition for CMP may be decreased when the slurry composition for CMP has a contact angle of less than 10°, and polishing of a carbon film may not be smoothly inhibited when the slurry composition for CMP has a contact angle of more than 70°.

Polishing of the carbon film may be effectively inhibited by adjusting the contact angle, thereby maximizing interaction between the carbon film and the slurry composition.

In an example embodiment, the slurry composition for CMP may have a surface energy of 3 mN/m to 30 mN/m.

The surface energy may be controlled by adjusting the contact angle, and polishing of the carbon film may be effectively inhibited by maximizing the interaction between the carbon film and the slurry composition through control of the surface energy. In an example embodiment, the slurry composition for CMP may have a pH range of 2.0 to 6.0. The slurry composition for CMP may preferably have a pH range of 2.0 to 4.5. A pH-adjusting agent may be added as an amount of adjusting pH of the slurry composition for CMP. The polishing speed may be deteriorated, and defects such as dishing and surface imbalance may occur when pH of the slurry composition for CMP is deviated from the range.

In an example embodiment, the slurry composition for CMP may further include the pH-adjusting agent.

In an example embodiment, since the pH-adjusting agent is advantageous in dispersion stability, the pH-adjusting agent may secure high speed polishing performance and. good polishing surface with respect to films that are polishing targets of the present disclosure.

In an example embodiment, the pH-adjusting agent may include at least one of benzylamine, monoethanolamine, diethanolamine, triethanolamine, trimethanolamine, dimethylbenzylamine, ethoxybenzylamine, monoisopropanolamine, aminoethylethanolamine, N,N-diethylethanolamine, diethylenetriamine (DETA), triethylenetetramine (TETA), tetraethylenepentamine (TEPA), pentaethylenehexamine (PEHA), bis(hexanmethylene)triamine, N-(3-aminopropyl)ethylenediamine (Am3), N,N′-bis(3-aminopropyl)ethylenediamine (Am4), N,N′,N′-tris(3-aminopropyl)ethylenediamine (Am5), N-3-aminopropyl-1,3-diaminopropane, N,N′-bis(3 -aminopropyl)-1,3-diaminopropane, N,N,N′-tris(3-aminopropyl)-1,3-diaminopropane, bis-(3-aminopropyl)amine, dipropylenetriamine, and tripropylenetetramine.

in an example embodiment, the pH-adjusting agent may be present in an amount of 0.01 wt % to 1 wt % in the slurry composition for CMP. The polishing speed is deteriorated when the pH-adjusting agent is present in an amount of less than 0.01 wt % in the slurry composition for CMP, and there is a concern about overpolishing of polishing target films when the pH-adjusting agent is present in an amount of more than 1 wt % in the slurry composition for CMP.

In an example embodiment, a polishing target film may include at least one of a nitride film, an insulation film, a metal film, a poly silicon film, and a carbon film. Preferably, polishing target films of a slurry composition for CMP according to example embodiments of the present disclosure may include all of a nitride film, an insulation film, a metal film, a polysilicon film, and a carbon film. The insulation film may be an oxide film.

In an example embodiment, the carbon film may include a carbon film containing a carbon-hydrogen (C—H)) bond.

In an example embodiment, the carbon film may include at least one of an amorphous carbon layer (ACL), Advanced Patterning Film™ (APF) (trade name, manufactured by Applied Materials (AMAT) Inc.), SiLK (trade name, manufactured by Dow Chemical Company), Non-conductive Paste (NCP) (trade name, manufactured by ASM), an ashable hard mask (AHM) (trade name, manufactured by Novellous), and a carbon-based spin-on hard mask (C—SOH) film.

In an example embodiment, although the C-SOH film general means a carbon-based hard mask film, the C—SOH film overally means a carbon-based film having a resist function of a gap-filling or etching prevention film or the like filling via-holes of an inorganic film such as a resist film formed in self-aligned double patterning technology (SaDPT) or a silica film deposited on a patterned wafer in the present disclosure.

In an example embodiment, a polishing selectivity of the nitride film:insulation film:metal film:polysilicon film may be 0.5 to 1.5:0.5 to 1.5:0.5 to 1.5:0.5 to 1.5. Preferably, the polishing selectivity of the nitride film:insulation film:metal film:polysilicon film may be 1:1:1:1, and the polishing selectivity may be adjusted by including at least one of a metal polishing improver, a metal polishing inhibitor, a nitride film polishing improver, a nitride film polishing inhibitor, a poly film polishing improver, and a poly film polishing inhibitor.

In an example embodiment, the carbon film may have a polishing amount of less than 20 Å/min. The polishing amount of the carbon film may be preferably about 15 Å/min or less, or about 12 Å/min. More preferably, the polishing amount of the carbon film may be 0 Å/min, and may have a carbon stop function. The polishing rate of the carbon film may be measured at a polishing down force pressure of 2.0 psi.

Hereinafter, the present disclosure will be described in more detail with reference to Examples and Comparative Examples.

However, the following Examples are illustrative only, and the contents of the present disclosure are not limited thereto.

### Example 1

After dispersing 5 wt % of a colloidal silica in 65 wt % of deionized. water to obtain a dispersion, a slurry composition for CMP was prepared by injecting 0.003 wt % of ammonium lauryl sulfate as a carbon polishing inhibitor and 0.5 wt % of hydrogen peroxide as an oxidizer into the dispersion, and mixing the carbon polishing inhibitor and oxidizer with the dispersion for 30 minutes.

### Example 2

A slurry composition. for CMP was prepared in the same manner as in Example 1 except that 0.2 wt % of ammonium lauryl sulfate as the carbon. polishing inhibitor was added in Example 1.

### Example 3

A slurry composition for CMP was prepared in the same manner as in Example 1 except that 0.003 wt % of sodium dodecyl sulfate as the carbon polishing inhibitor was added in Example 1.

### Example 4

A slurry composition for CMP was prepared in the same manner as in Example 3 except that 0.2 wt % of sodium dodecyl sulfate as the carbon polishing inhibitor was added in Example 3.

### Example 5

A slurry composition for CMP was prepared in the same manner as in Example 1 except that 0.003 wt % of sodium polyoxyethylene alkyl aryl sulfate as the carbon polishing inhibitor was added in Example 1.

### Example 6

A slurry composition for CMP was prepared in the same manner as in Example 5 except that 0.2 wt % of sodium polyoxyethylene alkyl aryl sulfate as the carbon polishing inhibitor was added in Example 5.

### Example 7

A slurry composition for CMP was prepared in the same manner as in Example 1 except that 0.003 wt % of ammonium polyoxyethylene alkyl aryl sulfate as the carbon polishing inhibitor was added in Example 1.

### Example 8

A slurry composition for CMP was prepared in the same manner as in Example 7 except that 0.2 wt % of ammonium polyoxyethylene alkyl aryl sulfate as the carbon polishing inhibitor was added in Example 7.

### Example 9

A slurry composition for CMP was prepared in the same manner as in Example 1 except that 0.003 wt % of cocamidopropyl betaine as the carbon polishing inhibitor was added in Example 1.

### Example 10

A slurry composition for CMP was prepared in the same manner as in Example 9 except that 0.2 wt % of cocamidopropyl betaine as the carbon polishing inhibitor was added in Example 9.

### Example 11

A slurry composition for CMP was prepared in the same manner as in Example 1 except that 0.003 wt % of alkyl ether phosphate as the carbon polishing inhibitor was added in Example 1.

### Example 12

A slurry composition for CMP was prepared in the same manner as in Example 11 except that 0.2 wt % of alkyl ether phosphate as the carbon polishing inhibitor was added in Example 11.

### Comparative Example 1

A slurry composition was prepared in the same manner as in Example 1 except that the carbon polishing inhibitor was not added in Example 1.

### Comparative Example 2

A slurry composition was prepared in the same manner as in Example 1 except that 0.003 wt % of polyacrylic acid instead of the carbon polishing inhibitor was added in Example 1.

### Comparative Example 3

A slurry composition was prepared in the same manner as in Example 1 except that 0.003 wt % of sodium oxalate instead of the carbon polishing inhibitor was added in Example 1.

Polishing was carried out under the following polishing conditions by using the slurry compositions for CMP of Examples 1 to 12 and the slurry compositions of Comparative Examples 1 to 3.

[Polishing Conditions]

1. Polishing machine: ST (manufactured by KCT Co., Ltd.)

2. Carrier RPM: 87 rpm

3. Platen RPM: 93 rpm

4. Wafer pressure: 2.0 psi

5. R-ring pressure: 6.5 psi

6. Slurry flow rate: 250 ml/min

7. Polishing pad: IC 1000 (manufactured by Dow)

8. Wafer: Carbon (content of 40% or more)

[Measurement Condition]

1. Measuring instrument: DSA100 (manufactured by KRUSS GmbH)

The following Table 1 shows polishing amounts of carbon films using the slurry compositions for CMP of Examples 1 to 12 and the slurry compositions of Comparative Examples 1 to 3.

TABLE 1

| | | Carbon | | | | | | | |
|---|---|---|---|---|---|---|---|---|---|
| | | polishing | | Contact | Poly-Si | W | Ox | Si₃N₄ | Carbon |
| | Particles | inhibitor | Oxidizer | angle | RR | RR | RR | RR | RR |
| Items | (wt %) | (wt %) | (wt %) | (°) | (Å/min) | (Å/min) | (Å/min) | (Å/min) | (Å/min) |
| Example 1 | Silica | Ammonium | Hydrogen | 64.1 | 454 | 723 | 750 | 660 | 9 |
| | (5) | lauryl sulfate | peroxide | | | | | | |
| | | (0.003) | (0.5) | | | | | | |
| Example 2 | Silica | Ammonium | Hydrogen | 48.3 | 389 | 699 | 764 | 624 | 4 |
| | (5) | lauryl sulfate | peroxide | | | | | | |
| | | (0.2) | (0.5) | | | | | | |
| Example 3 | Silica | Sodium | Hydrogen | 61.5 | 439 | 704 | 789 | 662 | 11 |
| | (5) | dodecyl sulfate | peroxide | | | | | | |
| | | (0.003) | (0.5) | | | | | | |
| Example 4 | Silica | Sodium | Hydrogen | 39.4 | 411 | 716 | 764 | 651 | 6 |
| | (5) | dodecyl sulfate | peroxide | | | | | | |
| | | (0.2) | (0.5) | | | | | | |
| Example 5 | Silica | Sodium | Hydrogen | 59.2 | 391 | 723 | 779 | 638 | 12 |
| | (5) | polyoxyethylene | peroxide | | | | | | |
| | | alkyl aryl | (0.5) | | | | | | |
| | | sulfate (0.003) | | | | | | | |
| Example 6 | Silica | Sodium | Hydrogen | 41.3 | 409 | 704 | 746 | 649 | 6 |
| | (5) | polyoxyethylene | peroxide | | | | | | |
| | | alkyl aryl | (0.5) | | | | | | |
| | | sulfate (0.2) | | | | | | | |
| Example 7 | Silica | Ammonium | Hydrogen | 69.2 | 426 | 719 | 715 | 627 | 9 |
| | (5) | polyoxyethylene | peroxide | | | | | | |
| | | alkyl aryl | (0.5) | | | | | | |
| | | sulfate (0.003) | | | | | | | |
| Example 8 | Silica | Ammonium | Hydrogen | 44.6 | 419 | 720 | 736 | 648 | 2 |
| | (5) | polyoxyethylene | peroxide | | | | | | |
| | | alkyl aryl | (0.5) | | | | | | |
| | | sulfate (0.2) | | | | | | | |
| Example 9 | Silica | Cocamidopropyl | Hydrogen | 66.0 | 423 | 733 | 774 | 699 | 10 |
| | (5) | betaine (0.003) | peroxide | | | | | | |
| | | | (0.5) | | | | | | |
| Example 10 | Silica | Cocamidopropyl | Hydrogen | 43.1 | 468 | 736 | 718 | 667 | 2 |
| | (5) | betaine (0.2) | peroxide | | | | | | |
| | | | (0.5) | | | | | | |
| Example 11 | Silica | Alkyl ether | Hydrogen | 67.1 | 446 | 690 | 769 | 684 | 9 |
| | (5) | phosphate | peroxide | | | | | | |
| | | (0.003) | (0.5) | | | | | | |
| Example 12 | Silica | Alkyl ether | Hydrogen | 45.6 | 440 | 688 | 728 | 682 | 4 |
| | (5) | phosphate | peroxide | | | | | | |
| | | (0.2) | (0.5) | | | | | | |
| Comparative | Silica | — | Hydrogen | 91.7 | 433 | 693 | 764 | 673 | 235 |
| Example 1 | (5) | | peroxide | | | | | | |
| | | | (0.5) | | | | | | |
| Comparative | Silica | Polyacrylic | Hydrogen | 89.3 | 429 | 687 | 762 | 649 | 259 |
| Example 2 | (5) | acid (0.003) | peroxide | | | | | | |
| | | | (0.5) | | | | | | |
| Comparative | Silica | Sodium oxalate | Hydrogen | 92.8 | 437 | 708 | 738 | 688 | 266 |
| Example 3 | (5) | (0.003) | peroxide | | | | | | |
| | | | (0.5) | | | | | | |

Referring to Table 1, it may be confirmed that, when using the slurry compositions for CMP of Examples 1 to 12, contact angles are less than 70°, and polishing rates in the carbon film are remarkably low compared to the slurry compositions of Comparative Examples 1 to 3. In addition, it may be confirmed that, if the contents of the carbon polishing inhibitors are high when using the same types of carbon polishing inhibitors, polishing rates in the carbon film are lower.

Although the above-mentioned example embodiments have been described by limited Examples, those skilled in the art may apply various modifications and alterations from the above-mentioned description. For example, appropriate results may be achieved although described techniques are carried out in a different order from a described method, and/or described elements are combined or mixed in a different form from the described method, or replaced or substituted with other elements or equivalents. Therefore, other embodiments, other Examples, and equivalents to patent claims belong to the scope of the patent claims to be described later.

What is claimed is:

1. A slurry composition for chemical mechanical polishing (CMP), the slurry composition comprising:
abrasive particles;
an oxidizer; and
a carbon polishing inhibitor.

2. The slurry composition of claim 1, wherein
the abrasive particles comprise at least one selected from the group consisting of a metal oxide, an organic or inorganic matter-coated metal oxide, and the metal oxide in a colloidal state, and
the metal oxide comprises at least one selected from the group consisting of silica, ceria, zirconia, alumina, titania, barium titania, germania, mangania, and magnesia.

3. The slurry composition of claim 1, wherein the abrasive particles include primary particles having a particle size of 10 nm to 200 nm and secondary particles having a particle size of 30 nm to 300 nm.

4. The slurry composition of claim 1, wherein the abrasive particles are present in an amount of 0.1 wt % to 10 wt % in the slurry composition.

5. The slurry composition of claim 1, wherein the oxidizer comprises at least one selected from the group consisting of hydrogen peroxide, urea hydrogen peroxide, urea, percarbonate, periodic acid, periodate, perchloric acid, perchlorate, perbromic acid, perbromate, perboric acid, perborate, permanganic acid, permanganate, persulfate, bromate, chlorate, chlorite, chromate, iodate, iodic acid, ammonium persulfate, benzoyl peroxide, calcium peroxide, barium peroxide, sodium peroxide, and carbamide peroxide.

6. The slurry composition of claim 1, wherein the oxidizer is present in an amount of 0.05 wt % to 5 wt % in the slurry composition.

7. The slurry composition of claim 1, wherein the carbon polishing inhibitor comprises an anionic surfactant, an amphoteric surfactant, or both thereof.

8. The slurry composition of claim 7, wherein the carbon polishing inhibitor comprises an anionic functional group with 6 to 20 carbon atoms, anionic and cationic functional groups with 6 to 20 carbon atoms, or both thereof.

9. The slurry composition of claim 7, wherein the anionic surfactant comprises at least one selected from the group consisting of ammonium lauryl sulfate, sodium dodecyl sulfate, sodium polyoxyethylene alkyl aryl sulfate, ammonium polyoxyethylene alkyl aryl sulfate, alkyl ether phosphate, sodium lauryl sulfate, sodium laureth sulfate, ammonium laureth sulfate, sodium cocoyl methyl taurate, disodium laureth sulfosuccinate, disodium lauryl sulfosuccinate, disodium cocoyl glutamate, sodium cocoyl glutamate, sodium cocoyl glycinate, sodium lauroyl sarcosinate, sodium cocoyl alaninate, sodium cocoyl isethionate, sodium lauroyl methyl isethionate, sodium laureth carboxylate, and sodium C14-16 olefin sulfonate.

10. The slurry composition of claim 7, wherein the amphoteric surfactant comprises at least one selected from the group consisting of cocamidopropyl betaine, lauramidopropyl betaine, alkyl betaine, amido betaine, sulfobetaine, hydroxysulfobetaine, amidosulfobetaine, phosphobetaine, imidazolinium betaine, alkyl amido betaine, alkyl amide propyl betaine, alkyl dimethyl amine betaine, alkyl dimethyl betaine, apricotamidopropyl betaine, coco amido betaine, coco betaine, cocoamidopropyl betaine, coco dimethyl betaine, lauryl betaine, lauryl amido propyl betaine, wheat germamidopropyl betaine, isostearamidopropyl betaine, myristamidopropyl betaine, palmitamidopropyl betaine, undecylenamidopropyl betaine, 2-alkyl-N-carboxymethyl-N-hydroxyethyl imidazolinium betaine, lauramidopropyl hydroxysultaine, lauryl hydroxysultaine, cocamidopropyl hydroxysultaine, sodium lauroamphoacetate, and sodium cocoamphoacetate.

11. The slurry composition of claim 1, wherein the carbon polishing inhibitor is present in an amount of 0.0001 wt % to 1 wt % in the slurry composition.

12. The slurry composition of claim 1, further comprising:
at least one selected from the group consisting of a metal polishing improver, a metal polishing inhibitor, a nitride film polishing improver, a nitride film polishing inhibitor, a poly film polishing improver, and a poly film polishing inhibitor.

13. The slurry composition of claim 1, wherein the slurry composition has a contact angle range of 10° to 70°.

14. The slurry composition of claim 1, wherein the slurry composition has a pH range of 2.0 to 6.0.

15. The slurry composition of claim 1, wherein a polishing target film comprises at least one selected from the group consisting of a nitride film, an insulation film, a metal film, a polysilicon film, and a carbon film.

16. The slurry composition of claim 15, wherein the carbon film has a polishing amount of less than 20 Å/min.
